(19) United States
(12) Patent Application Publication
(10) Pub. No.: US 2010/0298010 A1
(43) Pub. Date: Nov. 25, 2010

(54) METHOD AND APPARATUS FOR BACK-UP OF CUSTOMIZED APPLICATION INFORMATION

(75) Inventors: Daniel L. ROTH, Boston, MA (US); Laurence S. GILLICK, Newton, MA (US); Jordan COHEN, Half Moon Bay, CA (US)

Correspondence Address: WILMERHALE/BOSTON, 60 STATE STREET, BOSTON, MA, 02109, US

(73) Assignee: NUANCE COMMUNICATIONS, INC., Burlington, MA (US)

(21) Appl. No.: 12/644,652

(22) Filed: Dec. 22, 2009

Related U.S. Application Data
(63) Continuation of application No. 10/936,882, filed on Sep. 9, 2004, now abandoned.
(60) Provisional application No. 60/501,950, filed on Sep. 11, 2003.

(51) Int. Cl. G06F 15/16; G06F 17/30; G10L 15/00; H04W 4/14; H04B 7/00; H04W 88/02

(52) U.S. Cl. 455/466; 709/219; 707/803; 704/246; 455/41.2; 455/563; 707/E17.044; 704/E15.001

(57) ABSTRACT

A method of operating a mobile communication device having a set of one or more applications, each with its own associated user-configurable customization, the method comprising detecting whether the user-configurable customization of any of the applications has changed since an earlier time, and for all applications for which the user-configurable customization has changed since said earlier time, wirelessly transmitting those changes to a remote server. The method further comprises maintaining a set of flags indicating whether changes have occurred to the user-configurable customization, wherein detecting whether the user-configurable customization of any of the applications has changed since said earlier time includes reading the set of flags. The remote server is one of a carrier server and a third party provider server.

### CROSS-REFERENCE TO RELATED APPLICATIONS

This application claims benefit to U.S. Provisional Patent Application Ser. No. 60/501,950 filed Sep. 11, 2003 and is a continuation application of U.S. Non-Provisional Patent Application Ser. No. 10/936,882 filed Sep. 9, 2004, the entire contents of which are incorporated herein by reference.

### TECHNICAL FIELD

This invention relates to wireless communication devices.

### BACKGROUND

With the advent of speech applications on mobile computing devices such as cellular (cell) phones or personal digital assistants (PDAs), it is common, and sometimes necessary, to customize each application on a cell phone to the idiosyncrasies and preferences of the cell phone (or PDA) user. For instance, in a phone book the entries are associated with the phone user, the pronunciations might be customized to his or her accent, the phone numbers are certainly personal choice, and the settings of the application, for example, a choice list or not, confirmation or not, are customizable.

The device user generally spends a substantial amount of time to enter data and customize his or her application. This effort might be lost if the device is broken, stolen, or replaced. While it is standard to synchronize some of the data in these applications with a PC (personal computer) or PDA databases, this generally does not extend to the application or speech customization.

### SUMMARY OF THE INVENTION

In general, one aspect of the invention includes a method of operating a mobile communication device having a set of one or more applications, each with its own associated user-configurable customization, the method comprising detecting whether the user-configurable customization of any of the applications has changed since an earlier time, and for all applications for which the user-configurable customization has changed since said earlier time, wirelessly transmitting those changes to a remote server. The method further comprises maintaining a set of flags indicating whether changes have occurred to the user-configurable customization, wherein detecting whether the user-configurable customization of any of the applications has changed since said earlier time includes reading the set of flags. The remote server is one of a carrier server and a third party provider server.

The user-configurable customization is selected from a group comprising adaptive vocabulary, pronunciation information, acoustic models, preferences of a user such as phonebook entries, button mapping, and a plurality of settings of a plurality of applications. The user-configurable customization of the set of one or more applications is transmitted to the remote server either upon a user request or at a predetermined time.

The mobile communication device has a voice channel, an SMS (short messaging service) channel, and a (WAP) wireless application protocol channel, and wherein transmitting involves transmitting over one of the voice channel and the SMS data channel. The mobile communication device is enabled with a wireless protocol such as Bluetooth protocol or IP protocols such as 802.11 and, wherein transmitting involves using at least one wireless protocol.

According to another aspect of the invention, a method for saving user-configurable customized application information of a communication device having speech recognition capabilities, includes storing the customization data input as a database entry in the device; identifying at least one bit associated with each database entry that is indicative of an update to the customization data input entry; monitoring the at least one bit associated with each database entry to determine if an update has occurred; and transmitting the updated database entries to a remote server at a predetermined time or upon user request. The user-configurable customization includes preferences of a user such as phone number entries, adaptive vocabulary, pronunciation information, acoustic models, button mapping, and a plurality of settings of the application including choice lists, phonebook settings, and confirmation settings. The predetermined time is either a predetermined polling time of the communication device, or a predetermined polling time of the remote server. The method further includes clearing the at least one bit indicative of an update to the entry upon sending the updated database entries. The method also includes the device receiving an acknowledgement message of receipt of updated database entries from the remote server. The remote server is either a carrier or a third party provider.

In general, according to another aspect of the invention; a mobile communication device includes a wireless transceiver circuit for transmitting and receiving auditory information and for receiving data including application customization information; a processor; and a memory storing executable instructions when executed on the processor causes the mobile communication device to provide functionality to a user of the mobile communication device. The executable instructions includes detecting whether the user-configurable customizations associated with applications in the device have changed since an earlier time and wirelessly transmitting the changes to the customization information to a remote server. The mobile communication device is a mobile telephone device. The method includes maintaining a set of flags, for example, at least one bit associated with each database entry indicating that a change has occurred. The remote server is either a carrier server or a third party provider server. The customization information includes, but is not limited to, adaptive vocabulary, pronunciation information, acoustic models, preferences of a user such as phonebook entries, button mapping, and a plurality of settings of a plurality of applications such as choice lists, phonebook settings and confirmation settings.

According to another aspect of the invention, a method for configuring a mobile communication device that includes speech recognition capabilities, includes establishing communication between a remote server and a communication device, the remote server having saved therein a plurality of data indicative of user-configurable customizations associated with different application programs of the communication device; the remote server receiving a request to transmit the user-configurable customizations to the communication device; and the remote server transmitting the user-configurable customizations to the communication device. The remote server is either a carrier server or a third party provider server. The customization information comprises, but is not limited to adaptive vocabulary, pronunciation information, acoustic models, preferences of a user such as phonebook entries, button mapping, and a plurality of settings of a plurality of applications. The method uses a voice channel, or an SMS channel or another high-speed digital data channel to transmit the customization from the remote server to the device.

According to another aspect of the invention, a method for generating revenue by a carrier service includes the carrier service establishing an account for each of a plurality of wireless communication devices, wherein on each of the wireless communication devices there is a set of one or more application programs, each with its own user-configurable customizations; maintaining a backup of each of the user-configurable customizations for each device in a carrier database server and billing the account for services provided. The services include, but are not limited to, transmitting the customizations, storage of customizations, updating of customizations, and provisioning of new devices. The storing of the user-configurable customizations in the carrier database includes associating a user name and date with each database entry.

The foregoing and other features and advantages of the invention will be apparent from the following more particular description of embodiments of the invention, as illustrated in the accompanying drawings.

### BRIEF DESCRIPTION OF THE DRAWINGS

FIG. 1A is a flow diagram of a process for saving customized application information in mobile communication devices.

FIG. 1B is a flow diagram of a process for backing up customized application information on a remote server.

FIG. 2 is a flow diagram of a process to customize a different mobile communication device or update the device.

FIG. 3 is a block diagram of a cellular phone (Smartphone) on which the functionality described herein can be implemented.

### DETAILED DESCRIPTION

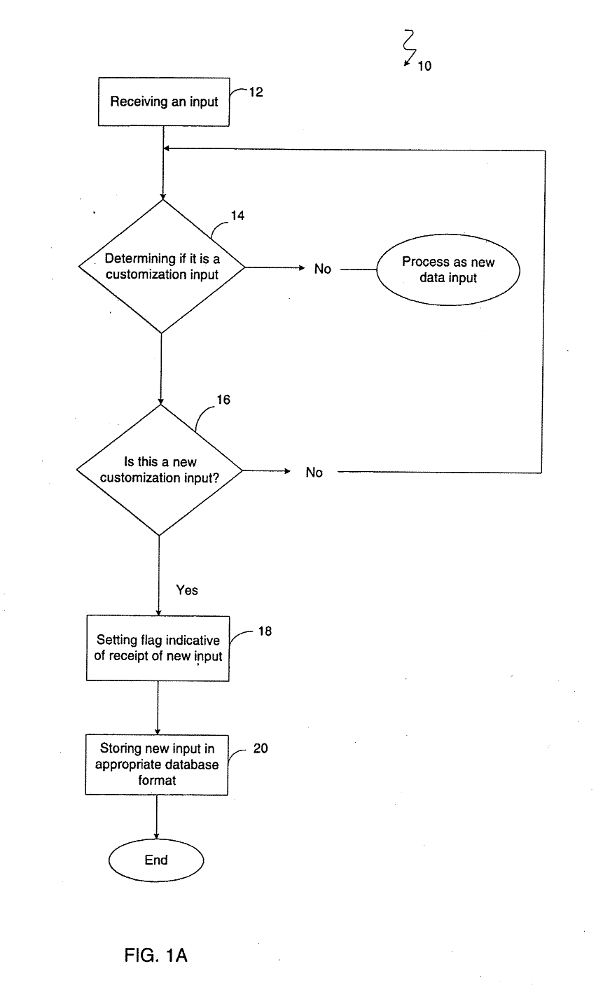

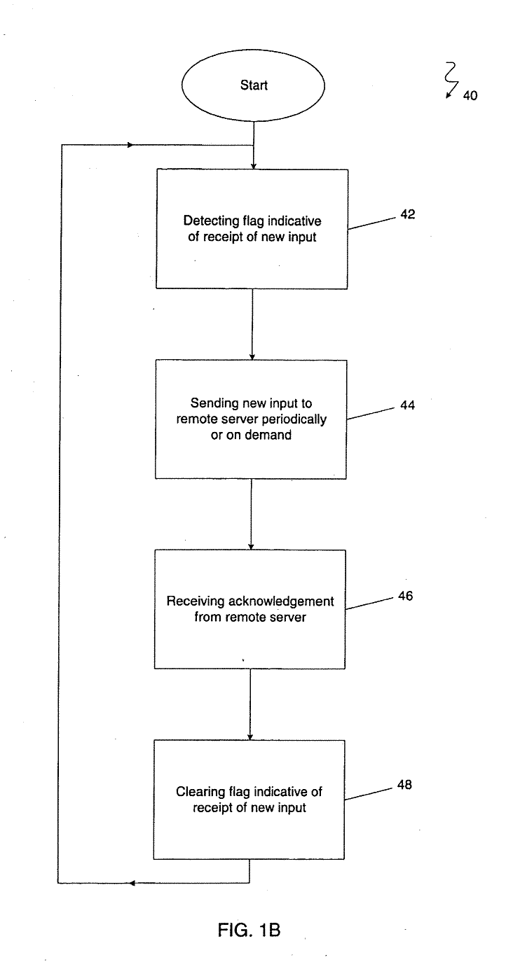

FIG. 1A illustrates a flow diagram of a process 10 for saving customized application information in mobile communication devices. A user of a mobile communication device customizes specific elements of applications provided by the mobile device. For instance, he or she may have entered new names in the phonebook, trained the digit recognizer to facilitate a digit dial functionality by simply speaking the digits, changed the pronunciation of “number dial” to “numerals”, and have a particular acoustic model. These user-configurable customizations are valued features for users who have unusual vocal characteristics or accents relative to the general population of a market. The device may require the user to make recordings of his or her voice which are then used to customize the applications. The user may have also customized the launch commands by selecting different combinations from a list of different commands, provided specific button mapping, text and audio prompts, labels for phone number types (for example, work vs. office), and language bundles. The user customizes his or her choice list which is a list of possible recognition results that closely match what the user just said. If no single result is obviously the correct one, the application displays a choice list and prompts the user to choose therefrom. The application software appropriately tracks the customization level of the device. The software also has a flag associated with each application, and possibly with each region of each application, so that it knows if there has been any customization since the last time the customization was saved.

The method 10 for saving customization information of applications on the mobile communications device includes receiving an input from the user of the device per step 12. This input is either a speech input or a text input. The application program embedded in the device then determines, per step 14, if the input is a customization input. Once it has been ascertained that the input is a customization input, the application program proceeds, per step 16, to determine whether it is a new customization input that needs to be saved. Per step 18, if the input is determined to be a new input that indicates a customization level of the device has been revised, the application program sets an appropriate flag associated with the customization input. The customization input and the corresponding flag are then stored in the device as a file, such as a database using a format that saves the flag indicating that the entry is a new input. The flag may be at least one bit associated with each database entry. For example, one bit may be associated with an automatic update and another bit with a demand update.

FIG. 1B is a flow diagram of a process 40 for backing up the customization information onto a remote server which is either a carrier server or a third party server. The mobile communication device has an application that monitors and tracks changes to the customization of the device. The application detects flags indicating changes to customization per step 42.

Every mobile communication device such as a cell phone is connected to one or more networks. These networks are not always active, and each network has a different transport mode, data rate, and charge structure associated with its use. Some examples of networks are the voice channel (the standard cell phone channel which is typically a digital channel with data rates from approximately 9 to 25 kbits per second); a low speed data channel used for SMS (Short Messaging Service) and for message indicators; and a high speed digital channel (in CDMA 2000×1 less than 144 kbits per second, depending on service quality); and per UMTS (Universal Mobile Telephoning System) (3G) a digital channel with data rates of less than 2M bytes per second. Some mobile devices are also enabled with digital wireless protocols such as Bluetooth and/or 802.11 available, so there is an alternate high-speed IP (Internet Protocol) network.

Periodically, or on demand, the mobile device wakes up and polls the data services available to it per step 44. It then sends all of the updated customization information (i.e., information that has changed since the last transmission of such information) to an information location on either the carrier's servers or on the servers of a third party provider connected to the carrier. The information is stored in the remote server such that it is associated with the name of the owner (or user) of the mobile device, and with the date of the storage.

The software sets the aforementioned flag when the associated feature or customization information is updated or modified. The process 40 includes an acknowledgement step 46 wherein the remote server in receipt of the updated customization information sends a message confirming receipt of input back to the mobile device. The software clears the flag per step 48 when that customization information is downloaded to the carrier's or third party servers. The software only sends information when the flag indicates that it has updated information since the last back-up. In an embodiment, the software provides a full save of all the customizations to a remote server which allows for a customization of a new but compatible mobile communication device.

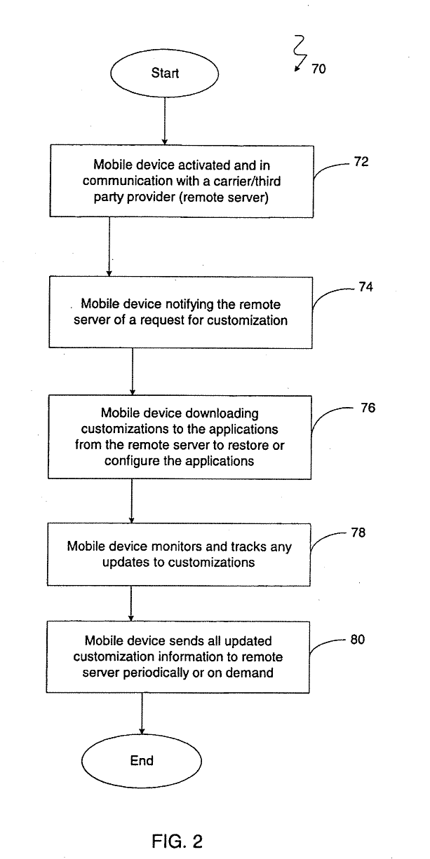

FIG. 2 is a flow diagram of a process 70 for downloading, from a remote server (either third party or carrier server), previously saved customizations to applications of a mobile communication device. When the owner or user wants to update the device, or to customize a different device, he or she simply notifies the carrier or service provider with a request for customization per step 74, and any available network may be used to download the previously saved customization information into the current device per step 76. “Smart” software in a device analyzes the cost of the various options, and either gives the user a choice of channels, or simply uses the least expensive update path.

This can be done for any customization information beyond that which was already mentioned including, for example, a new language model, new names for the address or contact book, new pronunciations, and a trained model that the user has adapted to his or her use.

The customization information that is backed-up is either identified by the carrier or some other third party. Or the software on the phone enables the user to specify the customization information that he or she wants to have backed-up in this way.

This back-up service can be a service that the carrier (or a third party working through the carrier) sells to users. Thus, it provides a potential new revenue stream for providers of the cell phone services. The user account may be billed for, but not limited to, transmitting updates, storage of information, updating information, and provisioning of new devices.

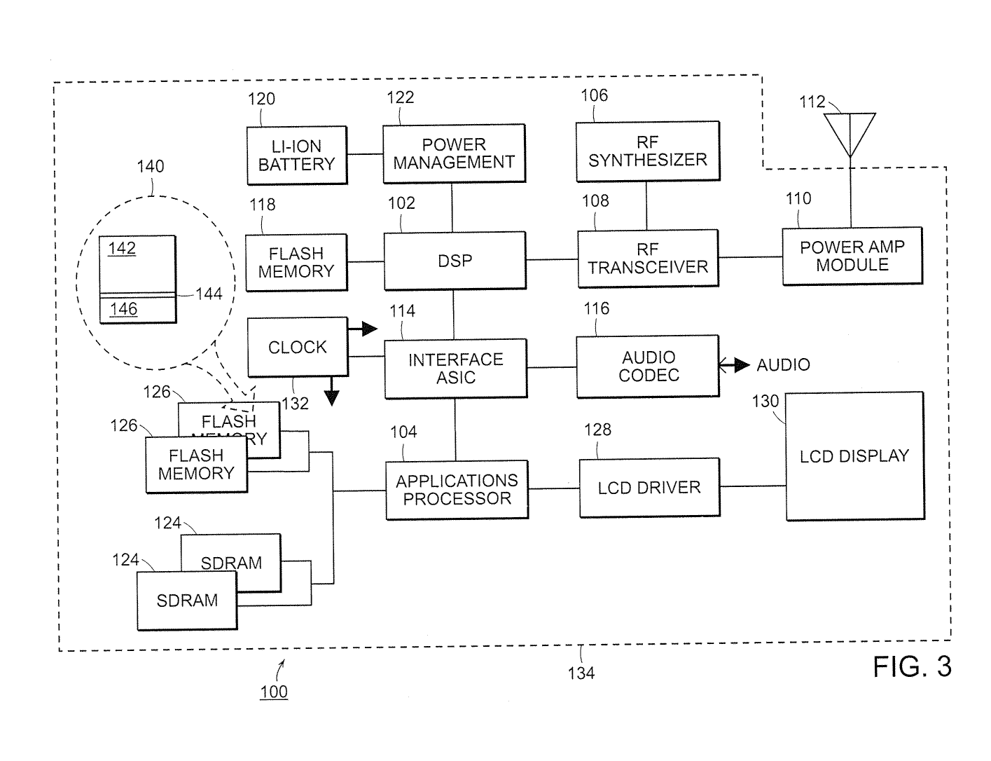

A typical platform on which such functionality can be provided is a smartphone 100, such as is illustrated in the high-level block diagram form in FIG. 3. The platform is a cellular phone in which there is embedded application software that includes the relevant above-described functionality. In this instance, the application software includes, among other programs, voice recognition software that enables the user to access information on the phone (for example, telephone numbers of identified persons) and to control the cell phone through verbal commands. The voice recognition software also includes enhanced functionality in the form of a speech-to-text function that enables the user to enter text into an email message through spoken words.

In the described embodiment, smartphone 100 is a Microsoft PocketPC-powered phone which includes at its core a baseband DSP 102 (digital signal processor) for handling the cellular communication functions including, for example, voiceband and channel coding functions and an applications processor 104 (for example, Intel StrongArm SA-1110) on which the PocketPC operating system runs. The phone supports GSM (global system for mobile communications) voice calls, SMS (Short Messaging Service) text messaging, wireless email (electronic mail), and desktop-like web browsing along with more traditional PDA features.

The transmit and receive functions are implemented by an RF (radio frequency) synthesizer 106 and an RF radio transceiver 108 followed by a power amplifier module 110 that handles the final-stage RF transmit duties through an antenna 112. An interface ASIC 114 (application specific integrated circuit) and an audio CODEC 116 (compression/decompression) provide interfaces to a speaker, a microphone, and other input/output devices provided in the phone such as a numeric or alphanumeric keypad (not shown) for entering commands and information.

The DSP 102 uses a flash memory 118 for code store. A Li-Ion (lithium-ion) battery 120 powers the phone and a power management module 122 coupled to DSP 102 manages power consumption within the phone. Volatile and non-volatile memory for applications processor 114 is provided in the form of SDRAM 124 (synchronized dynamic random access memory) and flash memory 126, respectively. This arrangement of memory is used to hold the code for the operating system, the code for customizable features such as the phone directory, and the code for any applications software that might be included in the smartphone, including the voice recognition software mentioned herein before. The visual display device for the smartphone includes an LCD (liquid crystal display) driver chip 128 that drives an LCD display 130. There is also a clock module 132 that provides the clock signals for the other devices within the phone and provides an indicator of real time.

All of the above-described components are packaged within an appropriately designed housing 134.

Since the smartphone described above is representative of the general internal structure of a number of different commercially available smartphones and since the internal circuit design of those phones is generally known to persons of ordinary skill in this art, further details about the components shown in FIG. 2 and their operation are not being provided and are not necessary to understanding the invention.

The internal memory of the phone includes all relevant code for operating the phone and for supporting its various functionality, including code 140 for the voice recognition application software, which is represented in block form in FIG. 2. The voice recognition application includes code 142 for its basic functionality as well as code 144 for enhanced functionality, which in this case is speech-to-text functionality 144. The code or sequence of executable instructions for the methods for saving customized application information including acoustic models and adapted vocabulary as described herein are stored in the internal memory of a phone and as such can be implemented on any phone, PDA or generally any communication device having an application processor.

In view of the wide variety of embodiments to which the principles of the present invention can be applied, it should be understood that the illustrated embodiments are exemplary only, and should not be taken as limiting the scope of the invention. For example, the steps of the flow diagrams may be taken in sequences other than those described, and more or fewer elements may be used in the diagrams. While various elements of the preferred embodiments have been described as being implemented in software, other embodiments in hardware or firmware implementations may alternatively be used, and vice-versa.

It will be apparent to those of ordinary skill in the art that methods involved in the automatic or commanded backup of customized application information may be embodied in a computer program product that includes a computer usable medium. For example, such a computer usable medium can include a readable memory device, such as, a hard drive device, a CD-ROM, a DVD-ROM, or a computer diskette, having computer readable program code segments stored thereon. The computer readable medium can also include a communications or transmission medium, such as, a bus or a communications link, either optical, wired, or wireless having program code segments carried thereon as digital or analog data signals. The methods for saving customized application information can be implemented on mobile communication devices having different computing platforms.

Other aspects, modifications, and embodiments are within the scope of the following claims.

1-40. (canceled)

41. A method of backing up information used for customizing voice recognition software on a mobile communications device that communicates over a carrier network provided by a carrier, the method comprising:
storing information associated with a customization of voice recognition software on the mobile communications device, the stored information including at least one of an acoustic model, a language model, an adaptive vocabulary, and pronunciation information; and
upon detecting a change in at least one of the acoustic model, the language model, the adaptive vocabulary, and the pronunciation information, wirelessly transmitting over the carrier network for storage in a remote server accessible to the carrier the change to the at least one of the acoustic model, the language model, the adaptive vocabulary, and the pronunciation information in support of future updates to the voice recognition software on the mobile communications device.

42. The method of claim 41, further comprising maintaining a set of flags indicating whether changes have occurred to the stored information, wherein detecting whether the stored information has changed since said earlier time includes reading the set of flags.

43. The method of claim 42, further comprising in addition to wirelessly transmitting said changes to the remote server, clearing all flags of the set of flags that had indicated that changes had occurred.

44. The method of claim 41, wherein the stored information is transmitted to the remote server.

45. The method of claim 41, wherein transmitting said changes occurs by one of upon a user request and at a predetermined time.

46. The method of claim 45, wherein the predetermined time comprises at least one of a predetermined polling time of the device and a predetermined polling time of the remote server.

47. The method of claim 41, wherein the mobile communications device has a voice channel, an SMS (short messaging service) channel, and a (WAP) wireless application protocol channel, and wherein transmitting involves transmitting over one of the voice channel, the WAP channel and the SMS data channel.

48. A method of backing-up information used for customizing voice recognition software on a mobile communications device that communicates over a carrier network provided by a carrier, the method comprising:
storing information associated with a customization of voice recognition software on the mobile communications device, the stored information including at least one of an acoustic model, a language model, an adaptive vocabulary, and pronunciation information as a database entry in the device;
identifying at least one bit associated with each database entry that is indicative of an update to the stored information;
monitoring said at least one bit associated with each database entry to determine if an update to the stored information has occurred; and
in response to determining that an update to the stored information has occurred, transmitting over the carrier network for storage in a remote server accessible to the carrier the update to the stored information at one of a predetermined time and upon user request.

49. The method of claim 48, wherein a predetermined time comprises at least one of a predetermined polling time of the communications device, or a predetermined polling time of the remote server.

50. The method of claim 49, further comprising clearing the at least one bit indicative of an update to said entry upon sending the updated database entries.

51. The method of claim 48, further comprising the device receiving an acknowledgement message of receipt of updated database entries from the remote server.

52. The method of claim 48, wherein the communication device has a voice channel and an SMS data channel and wherein transmitting involves transmitting over one of the voice channel and the SMS data channel.

53. The method of claim 48, wherein the communication device is enabled with a wireless protocol selected from a group consisting of Bluetooth protocol, and internet-protocols such as 802.11 and wherein transmitting involves using one of said wireless protocols.

54. A mobile communications device that includes customizable voice recognition software, the device comprising:
a wireless transceiver circuit for transmitting and receiving auditory information and data including application customization information over a carrier network provided by a carrier;
a processor; and
a memory storing executable instructions for executing customizable voice recognition software on the processor, the memory further storing information associated with the voice recognition software including at least one of an acoustic model, a language model, an adaptive vocabulary, and pronunciation information; and
when executed on the processor said instructions causing the mobile communication device to provide functionality to a user of the mobile communication device, including detecting whether at least one of the acoustic model, the language model, the adaptive vocabulary, and the pronunciation information has changed since an earlier time and for all instances in which at least one of the acoustic model, the language model, the adaptive vocabulary, and the pronunciation information has changed since said earlier times, wirelessly transmitting those changes over the carrier network for storage in a remote server accessible to the carrier.
